(19) United States
(12) Patent Application Publication
(10) Pub. No.: US 2015/0224695 A1
(43) Pub. Date: Aug. 13, 2015

(54) Injection Molding Apparatus and Method Comprising a Mold Cavity Surface Comprising a Thermally Controllable Array

(71) Applicant: 3M INNOVATIVE PROPERTIES COMPANY, St. Paul, MN (US)

(72) Inventors: Karl K. Stensvad, Inver Grove Heights, MN (US); Stanley Rendon, Eagan, MN (US); Samuel Kidane, St. Paul, MN (US)

(21) Appl. No.: 14/416,243

(22) PCT Filed: Jun. 26, 2013
(86) PCT No.: PCT/US2013/047937

§ 371 Date: Jan. 21, 2015

Related U.S. Application Data
(60) Provisional application No. 61/677,573, filed on Jul. 31, 2012.

(51) Int. Cl. B29C 45/73; B29C 45/76

(52) U.S. Cl. CPC B29C 45/7306; B29C 45/76; B29L 2031/00

(57) ABSTRACT

Apparatus and methods for injection molding, in which at least one portion of at least one cavity surface that defines a mold cavity, includes a thermally controllable array.

### BACKGROUND

Injection molding is often performed in the making shaped polymeric parts. Such molding typically uses two or more mold components (parts) that are brought together (e.g., on platens) to form a mold cavity. Such mold components are often maintained at a generally static temperature, or heated or cooled as a unit.

### SUMMARY

In broad summary, disclosed herein are apparatus and methods for injection molding, in which at least one portion of at least one cavity surface that defines a mold cavity, includes a thermally controllable array. These and other aspects of the invention will be apparent from the detailed description below. In no event, however, should the above summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a perspective view in partial cutaway, into a mold cavity comprising a molding surface comprising an exemplary thermally-controllable array.

FIG. 2 is a front-side perspective view of an exemplary temperature-controllable array and components associated therewith. FIG. 3 is an end elevated view of the exemplary apparatus of FIG. 2, which view also includes a portion of a mold cavity, shown in partial cross-section.

FIG. 4 is a rear plan view of the exemplary apparatus of FIG. 2.

FIG. 5 is a front-side perspective isolated view of a temperature-controllable element of the temperature-controllable array of the exemplary apparatus of FIG. 2.

FIG. 6 is a side perspective isolated view of an exemplary support member of the exemplary apparatus of FIG. 2.

FIG. 7 is a schematic depiction of a temperature-controllable array and associated components for operating the temperature-controllable array.

FIG. 8 is a front-side perspective view of another exemplary apparatus comprising a temperature-controllable array and components associated therewith.

FIG. 9 is a rear-side perspective view of the exemplary apparatus of FIG. 8.

FIG. 10 is a perspective view in partial cutaway, into a mold cavity comprising a molding surface comprising an exemplary thermally-controllable array.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only, for ease of description with reference to the particular drawing views shown, unless otherwise noted. As used herein, terms such as front, frontward, frontwardly, front-facing, frontmost, forward, forwardly, forwardmost, forward-facing, etc., denote a direction toward a mold cavity formed when first and second mold components are brought together. Terms such as rear, rearward, rearwardly, rearmost, rear-facing, etc. denote a direction away from such a mold cavity.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties); the term “substantially” means to a high degree of approximation (e.g., within +/−10% for quantifiable properties) but again without requiring absolute precision or a perfect match. Terms such as strictly, same, equal, uniform, constant, and the like, as applied to a quantifiable property or attribute, mean within +/−5%, unless otherwise defined herein.

### DETAILED DESCRIPTION

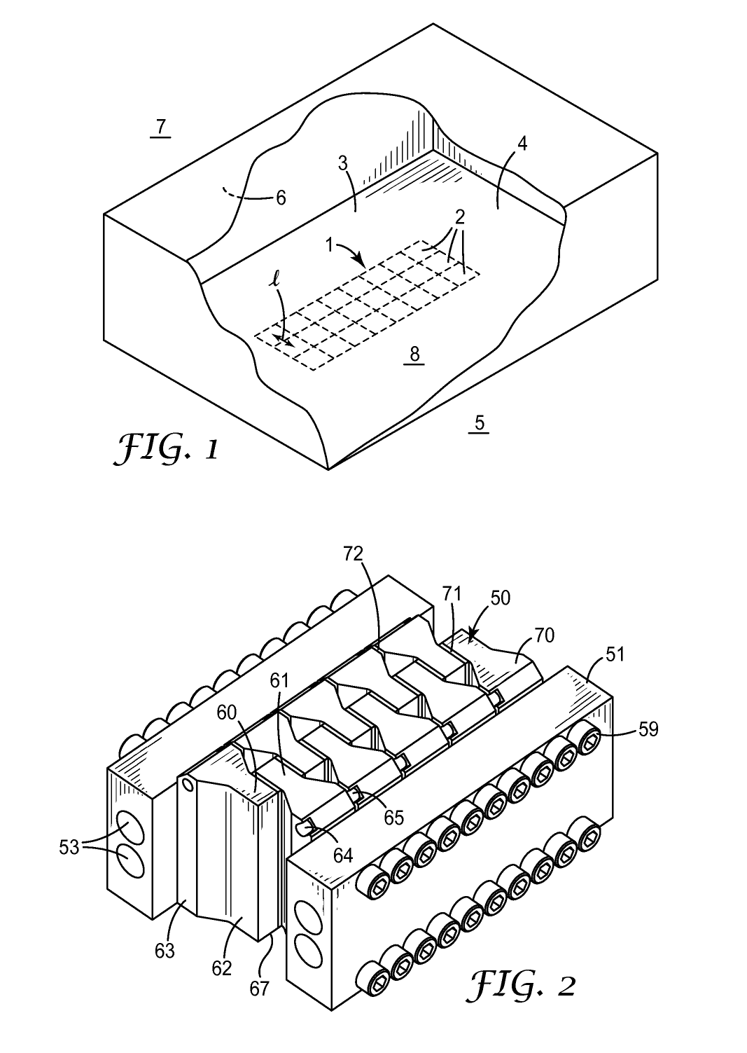

Disclosed herein is an apparatus and method for temporal and spatial control of thermal energy in a molding surface of an injection-molding cavity. An exemplary mold cavity 8 is shown in generic representation in FIG. 1. Those of ordinary skill will appreciate that a mold cavity 8 may be provided e.g. by bringing together a first mold component 5 comprising at least a first molding surface 4, and a second mold component 7 comprising at least a second molding surface 6. (It is emphasized that FIG. 1 is a simplified representation of a mold cavity, with features such as parting lines between the first and second mold components, sprues, gates, runners, ejector pins, etc., omitted for clarity.) As disclosed herein, front surface 4 of mold cavity skin 3 defines at least a portion of mold cavity 8. At least one thermally-controllable array 1 is provided over some region of surface 4. The term thermally-controllable array is used broadly herein to encompass any plurality of (i.e., at least two or more) areas 2 of surface 4 whose temperatures are individually and separately manipulable (noting that the use of the term “array” here and elsewhere herein does not imply that areas of an array must necessarily be arranged in a regular, uniform, or symmetrical pattern). Array 1 is referred to for convenience herein as a thermally-controllable array rather than as a temperature-controllable array, in view of the fact that the temperature of an individual area 2 of array 1 may not necessarily be capable of being directly monitored (although this could be done if desired). This nomenclature will distinguish thermally-controllable array 1 from the below-described temperature-controllable arrays the temperature of whose individual elements may be directly monitored and controlled.

For convenience of description, individual areas 2 of an array 1 may be referred to herein as pixels. It will be understood that pixels 2 of array 1 are areas of surface 4, which areas may not necessarily, and in most cases will not, have any physical border or separating feature therebetween or be visibly distinguishable from each other. Rather, pixels 2 are merely areas of surface 4 of skin 3 that are capable of being individually thermally controlled (e.g., being stably held at temperatures that are different from each other), by way of being thermally coupled to temperature-controllable elements of a temperature-controllable array as discussed later herein. Pixels 2 may be present in any suitable number, size, shape and spacing as desired (and which arrangements may be achieved by the use of a desired number, size, shape and spacing of temperature-controllable elements of a temperature-controllable array as described in further detail herein).

As mentioned above, array 1 is provided in front surface 4 of mold cavity skin 3. In some embodiments, cavity skin 3 may be a thin skin, by which is meant that the thickness of skin 3, on average over the lateral extent of pixels 2 of array 1, is no more than about 5 mm. In further embodiments, the thickness of skin 3 may be less than about 2, 1, 0.5 or 0.3 mm. In some embodiments, cavity skin 3 may be a low-thermal-conductivity skin, by which is meant that the material of skin 3, in any particular pixel 2 of array 1, comprises a thermal conductivity of less than about 100 W/m-° C. In various embodiments, the material of skin 3 may comprise a thermal conductivity of less than about 80, 60, or 40 W/m-° C. In further embodiments, the material of skin 3 may comprise a thermal conductivity greater than about 5, 10, 20, or 25 W/m-° C. In some embodiments, the material of skin 3 may comprise a thermal conductivity that is less than 80%, 60%, 40%, or 20%, of the thermal conductivity of the material of a main body of a temperature-controllable element which the skin overlies and is thermally coupled to.

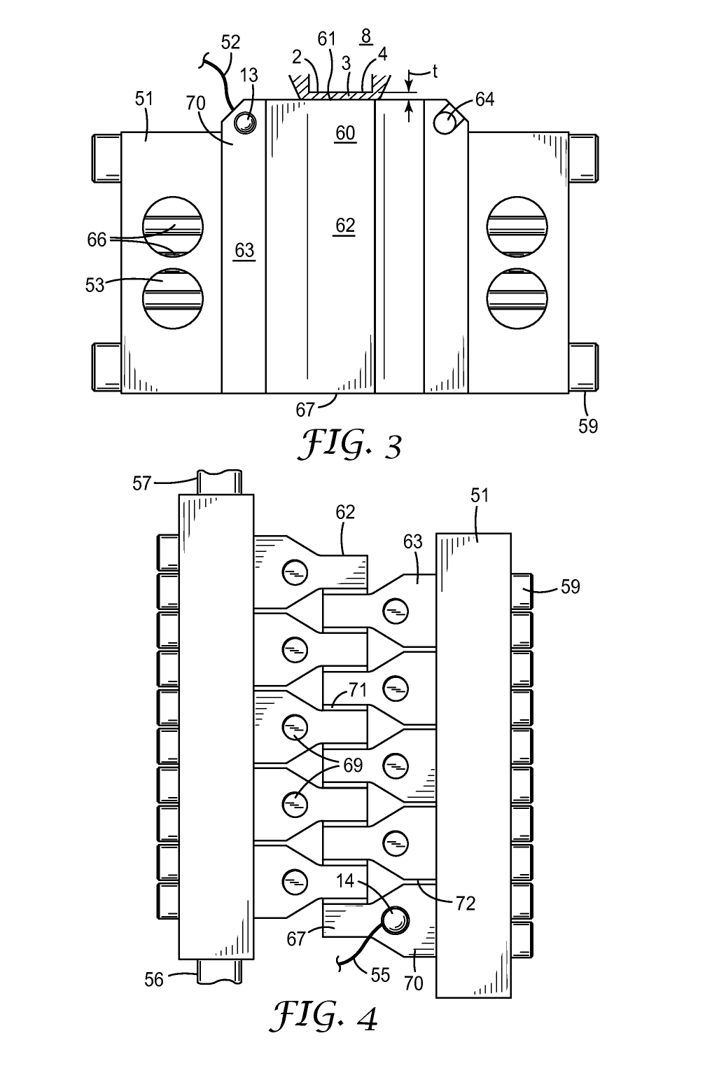

In broad summary, array 1, and individual pixels 2 thereof, may be thermally controlled, e.g. differentially thermally controlled, by way of a temperature-controllable array comprising individually temperature-controllable elements, each of which elements may be thermally coupled to a different individual pixel 2 of thermally-controllable array 1 so that each individual pixel 2 may be thermally controlled by changing the temperature of the temperature-controllable element to which it is thermally coupled. In practice, this may be accomplished by providing the temperature-controllable array so that a front surface of each element of the temperature-controllable array is thermally coupled to (e.g., is in intimate contact with) the rear surface of mold cavity skin 3 in a desired area (with front surface 4 of skin 3 in that area thus becoming a pixel 2 of array 1). While any temperature-controllable array may be used for such purposes, exemplary temperature-controllable arrays that may be particularly suitable are depicted in FIGS. 2-4 and 8-9 and will be discussed in further detail later herein.

Individual temperature-controllable elements of a temperature-controllable array may be laterally thermally isolated from each other, as discussed herein in detail. However, this does not necessarily preclude the existence of a lateral pathway for conduction of thermal energy between neighboring pixels that is provided by cavity skin 3. Rather (e.g. by way of skin 3 being sufficiently thin, and/or being made of a low-thermal-conductivity material), in some embodiments it may be provided that conduction of thermal energy through the thickness dimension of skin 3 (i.e., through the shortest dimension of the skin, running from the rear surface of the skin (that contacts a front face of a temperature-controllable element), to the front surface of the skin (that provides a molding surface of mold cavity 8)) is the dominant pathway for transmission of thermal energy through the skin, in comparison to lateral conduction of thermal energy along the skin (that is, from one pixel 2 to an adjacent pixel 2). This may provide that any particular pixel 2 may be satisfactorily thermally controlled by way of the temperature-controlled element that is thermally coupled to the rear surface of skin 3 of that pixel 2, generally independently of the conditions to which a nearest-neighbor pixel may be thermally controlled. For example, if a first pixel is held at a particular temperature or temperature range, an adjacent pixel may nevertheless be held at a temperature or temperature range (dictated by the temperature-controllable element that is thermally coupled to it) that is significantly higher or lower than that of the first pixel, without losing such an excess of thermal energy to, or receiving such an excess of thermal energy from, the first pixel, as to render it unable to satisfactorily hold the adjacent pixel in the desired temperature range.

The above principles may be characterized in terms of an aspect ratio for a pixel 2 of thermally-controllable array 1. Such an aspect ratio may be defined in terms of two parameters. The first parameter is the thickness “t” of the cavity skin 3 within pixel 2, along the thickness dimension of the skin (an exemplary distance “t” is shown in FIG. 3). The second parameter is the center-to-center distance “l” between the centerpoint of the pixel 2, and the closest centerpoint of a nearest-neighbor pixel 2. An exemplary distance “l” is shown in FIG. 1. (It will be appreciated that, as mentioned above, the shape, size, and centerpoint of a pixel 2 of array 1 may be largely dictated by the shape, size and centerpoint of a front surface (e.g., surface 61 of FIGS. 2 and 3) of a temperature-controllable element that is thermally coupled to cavity skin 3.) If a pixel 2 comprises a shape that is irregular or nonsymmetrical, the centroid (geometric center) of that pixel 2 may be used as the centerpoint for this purpose. With these parameters, the pixel aspect ratio can then be calculated as the l/t ratio. In various embodiments, a pixel 2 of a thermally-controllable array 1 may comprise an aspect ratio of at least about 2:1, 4:1, 8:1, or 16:1.

Thus in summary, the above-described arrangements make it possible for adjacent pixels 2 to be individually, e.g. differentially, thermally controlled (e.g., to be brought to, and/or maintained at, temperatures that may differ from each other by at least e.g. 5, 10, or 20 degrees C.). Accordingly, significant thermal gradients may be advantageously established and/or maintained over selected regions of molding surface 4 of cavity 8 (e.g., within array 1, and/or between array 1 and other, non-array regions of molding surface 4). It will be appreciated that even though such differential thermal control may be possible, in some instances two or more pixels of an array may be controlled to a similar or same temperature range. It will further be appreciated that, as mentioned above, some lateral conduction of thermal energy along mold cavity skin 3 (e.g. from a pixel to a neighboring pixel) may occur. However, some amount of thermal conduction along the mold cavity skin may not be disadvantageous as long as the desired thermal gradients may be maintained. In fact, some amount of thermal conduction along the mold cavity skin between adjacent pixels may advantageously provide that temperature changes between adjacent pixels 2 are not so abrupt as to e.g. cause disadvantageously sharp thermal gradients in a flowable (e.g., molten) resin that is in contact with adjacent pixels 2.

Thus, it will be appreciated that for neighboring edges of any two pixels, a temperature gradient may exist in the border area of each pixel that is proximate the neighboring edge of the pixel, rather than e.g. a near-vertical step change in temperature being present exactly at the border between the two pixels. It will also be understood that the temperature profile within even a laterally interior area of a pixel that is not proximate an edge of the pixel may not necessarily be completely flat. That is, in some circumstances the temperature within such a lateral area may exhibit variations (e.g., of 5, 2, 1, or 0.5 degrees C. or less). It will also be understood that the temperature of even such a laterally interior area of a pixel may, in some circumstances, fluctuate momentarily. Such a circumstance might arise e.g. when the pixel is contacted with a high-temperature molten resin.

The ordinary artisan will appreciate that the amount to which any of these deviations in temperature (e.g., away from a nominal setpoint established by a temperature-controllable element that is thermally coupled to the cavity skin in a particular area to provide a pixel thereon) may occur, and may depend e.g. on various factors such as the pixel size and proximity to other pixels, the nominal temperatures to which the pixel may be controlled, the aforementioned aspect ratio of the pixel, the temperature of a molding resin which is brought in contact with the pixel, and so on. However, it will be appreciated that, e.g. excepting any such minor and/or momentary fluctuations, and notwithstanding any deviations at or near the lateral edges of the pixel, in various embodiments the temperature of the laterally-interior area of a pixel 2 of an array 1 may be precisely controlled (e.g., to within plus or minus five degrees C., plus or minus two degrees C., or even plus or minus one degree C.). This may be the case whether or not the temperature of the pixel is actually directly monitored or not.

Shown in exemplary embodiment in FIGS. 2-4 is an exemplary temperature-controllable array 50 that may be thermally coupled to a cavity skin to provide a thermally-controllable array 1. While array 50 is merely one representative type of such a temperature-controllable array, it will be used to discuss general concepts and principles of such arrays. Exemplary temperature-controllable array 50 is comprised of individually temperature-controllable elements 60. As shown in FIG. 2 and particularly in FIG. 3, each individual element 60 of array 50 may comprise a main body 70 with a front surface 61 that is configured to be placed in intimate thermal contact with a rear surface of a cavity skin 3. In some embodiments, main body 70 may be of high thermal conductivity (e.g., greater than about 80 W/m-° C.), and in further embodiments may comprise a thermal conductivity of at least about 100, 150, 200, or 250 W/m-° C. In some embodiments main body 70 of element 60 may be made of metal. In particular embodiments, it may be made of a composition comprising copper or a copper alloy. In some embodiments, such a copper alloy may be a beryllium-copper alloy. In other embodiments, such a copper alloy may be a high-thermal-conductivity, beryllium-free copper alloy, as exemplified by materials available from Performance Alloys, Germantown, Wis. under the trade designation MOLDSTAR.

In the exemplary embodiment of FIG. 2, front surface 61 is provided on portion 62 of main body 70 of element 60, which portion 62 may serve as a load-bearing member. That is, member 62 may provide at least a part of a load-bearing path through a mold component (e.g., component 5 of FIG. 1), when first mold component 5 with which temperature-controllable array 50 is used, is brought together with a second mold component with a force commensurate with the injection pressure used in an injection molding operation.

Each main body 70 may also comprise a heat-exchange module 63 that is laterally adjacent to load-bearing member 62 (and is integrally connected thereto) and that may not necessarily have a surface that is in intimate contact with cavity skin 3. In this context, by laterally is meant in a direction that is at least generally orthogonal to the direction of thermal-energy-conduction through the thickness (shortest dimension) of skin 3 (which direction may also typically be at least generally orthogonal to the load-bearing pathway through member 62). As discussed below in detail, in the exemplary arrangement of FIGS. 2-4, thermal energy may be transferred into, and/or removed from, heat-exchange module 63 from an external source, and may then be laterally conducted from heat-exchange module 63 into load-bearing member 62, so as to bring the entirety of main body 70 (that is, both module 63 and member 62) to a desired temperature. This will bring front surface 61 of member 62 to this desired temperature and will thus allow thermal energy to be transferred therefrom to skin 3, or to be removed from skin 3, as desired.

By temperature-controllable is meant that the temperature of an individual element of a temperature-controllable array can be monitored (e.g., whether continuously, or intermittently at a frequency adequate to achieve the desired control), and that this monitored temperature can be used by a controller to direct the transfer of thermal energy to or from the element to change the temperature of the element e.g. to bring it to a desired setpoint; i.e., so that the element is subject to closed-loop temperature control. Such temperature monitoring may be achieved e.g. by the use of a temperature sensing device. While it may be convenient to use a so-called resistance temperature detector (RTD) for such purposes, any suitable temperature-sensing device may be used. It may be advantageous that such a temperature sensing device be positioned proximate the front side of the element (i.e., the side closest to the cavity skin to which the element is thermally coupled). Thus, in the exemplary embodiment of FIG. 2, each element 60 is provided with a cavity 64 which may receive a temperature sensing device (e.g., as represented by temperature sensing device 13 of FIG. 3) by which the temperature of that element 60 may be individually monitored. In the illustrated embodiment of FIG. 2, an access window 65 is provided so that a temperature sensing device may be connected to wiring (e.g., wire 52 of FIG. 3). However, any suitable method of communication (e.g., fiber optic, wireless, etc.) with such a temperature sensing device may be used.

Each element 60 may be heated and/or cooled by at least a first heat-transfer mechanism. In some embodiments, such a first heat-transfer mechanism may comprise a static mechanism, meaning that it does not involve a moving heat-transfer fluid which fluid is heated or cooled by a heating or cooling unit that is external to array 50 or to mold component 5. (As such, in some embodiments such a first heat-transfer mechanism encompasses a so-called heat-pipe comprising a heating or cooling fluid that is wholly contained inside, and is wholly internally recirculated within, a non-moving closed-end container. However, in other embodiments, no heat pipe is present within the array or within the mold component therewith.) In some embodiments, such a first, static heat-transfer mechanism may comprise electrical heating or cooling by way of an electrical heating/cooling element (e.g., element 14, as powered by wire 55, both shown in generic representation in FIG. 4). Such an element may be thermally coupled to main body 70 of element 60; e.g., it may be inserted into a rearwardly-open-ended cavity 69 of element 60 as shown in the rear view of FIG. 4, with element 14 being in intimate contact with main body 70 of element 60. (In the particular design of FIG. 4, heating/cooling element 14 is thermally coupled to heat-exchange module 63 so that thermal energy transferred thereinto may be laterally conducted into load-bearing member 62). While an electrical device capable of heating or cooling may be used (e.g., a Peltier device), in many instances it may be convenient to use a first, electrical heat-transfer mechanism, only for heating. In such embodiments electrically-driven static element 14 may be a heater (e.g., an electrical-resistance heater as are commonly known). However, any suitable type of heating or cooling element may be contacted with element 60 in any suitable manner and held thereagainst by any suitable fastening mechanism, as long as adequate thermal coupling is provided. For example, such an element may be held in place by external pressure; or, conductive adhesive, solder or the like may be used to attach it to main body 70.

Each element 60 may also be heated and/or cooled by a second heat-transfer mechanism that, in some embodiments, may be different from the first mechanism (it will be appreciated, of course, that the designations of first and second are arbitrary). A heat-transfer mechanism being different from another heat-transfer mechanism includes mechanisms that operate by a different physical principle, e.g. a dynamic mechanism versus a static mechanism as described herein. However, a heat-transfer mechanism being different from another heat-transfer mechanism also includes cases in which both mechanisms may operate by the same principle (e.g., both may involve dynamic heat-transfer via a moving heat-transfer fluid, or both may involve e.g. heating or cooling by a Peltier device) but in which the mechanisms are capable of being applied at least generally simultaneously to the same temperature-controllable element in opposition to each other (i.e. so that the effect of one mechanism may at least partially offset the effect of the other). Thus in a general sense, the same temperature-controllable element may be thermally coupled to a heat source, and also to a heat sink, that may respectively operate to add thermal energy to the element, and to remove thermal energy from the element, in a generally simultaneous or simultaneous manner. A specific example might be one in which a temperature-controllable element is e.g. simultaneously subjected to heating by a first heat-transfer fluid and to cooling by a second heat-transfer fluid that is controlled independently of the first heat-transfer fluid. In general, at any particular time, an element 60 may be heated or cooled by the first mechanism alone, by the second mechanism alone, by use of both in combination, or may not be heated or cooled by either mechanism, as discussed later herein in detail.

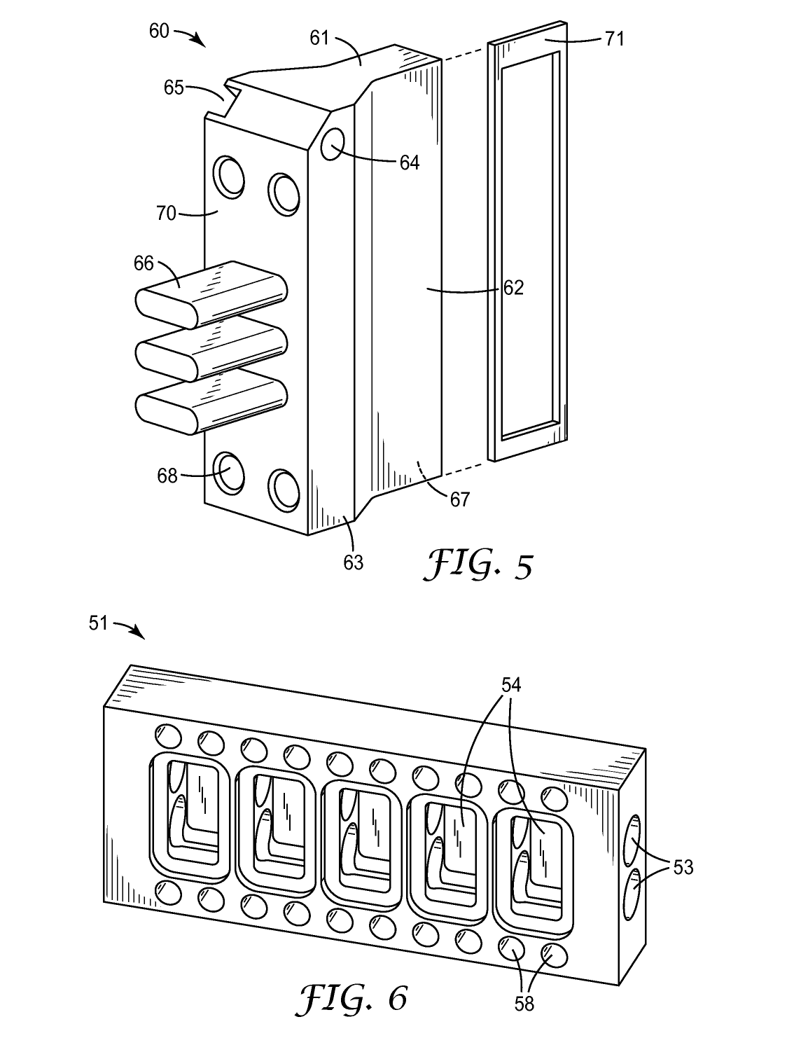

As exemplified in FIGS. 2-6, in some embodiments such a second heat-transfer mechanism may be a dynamic heat-transfer mechanism achieved by way of a moving heat-transfer fluid (whose temperature is controlled by a control unit that resides outside of array 50 and mold component 5) that transfers thermal energy to, or removes thermal energy from, main body 70 of element 60. Such dynamic heat-transfer capability may be achieved by providing that main body 70 of element 60 comprises at least one dynamic heat-transfer structure that is capable of directly or indirectly transferring thermal energy to, or receiving thermal energy from, such a moving heat-transfer fluid, which fluid may be gaseous (e.g., air, nitrogen, steam, etc.) or liquid (e.g., water, oil, etc.). In the particular embodiment of FIGS. 2-6, such a dynamic heat-transfer structure may take the form of one or more dynamic heat-transfer fins 66 as shown most clearly in FIGS. 3 and 5. The term dynamic heat-transfer fin is broadly defined herein as meaning any structure that protrudes from (e.g., is an integrally-protruding part of) main body 70 of element 60 and that has a high (meaning, in the specific context of a heat-transfer fin, at least 2:1) aspect ratio of fin height (protrusion distance) to fin thickness (meaning the average distance across the fin along its shortest axis, which shortest distance will often be along an axis that is generally orthogonal to the fin height axis and to the fluid flow direction). In various embodiments, the aspect ratio of such fins may be at least 3:1 or 5:1. Fins may be of any suitable shape and size, and may be present in any suitable number.

In the exemplary embodiment of FIGS. 2-6, temperature-controllable array 50 may be supported by one or more support blocks 51. In the exemplified design, a first support block 51 may be attached to main bodies 70 (e.g., to a laterally-outward portion of heat-exchange module 63 thereof) of a first set of elements 60. Such attachment may be by way of bolts 59 which may pass through bolt-holes 58 in support block 51 (as shown in FIG. 6), and may then pass into bolt-holes 68 in main body 70 of each element 60 (as shown e.g. FIG. 5), so as to attach main bodies 70 to support block 51 as shown in FIGS. 2-4. A similar second support block 51 may be attached to the main bodies of a second, oppositely-facing set of elements 60, again as shown in FIGS. 2-4. Support blocks 51 may then be attached e.g. to a mold base that is supported by a platen, as will be well understood by those of ordinary skill (often mold component 5 may be attached to the same mold base). In addition to supporting and stabilizing the elements 60 of array 50, a support block as pictured in FIGS. 2-6 may also serve the function of bringing a moving heat-transfer fluid into position to exchange thermal energy with main bodies 70 of elements 60. Thus, as most easily seen in the isolated view of a support block 51 shown in FIG. 6, support block 51 may comprise one or more (in the depicted embodiment, two) fluid-flow channels 53 that extend through the interior of support block 51 and that direct the moving heat-transfer fluid into and through spaces 54 in which heat-transfer structures (e.g., fins) 66 of main bodies 70 of elements 60 can reside so that the moving fluid may contact fins 66. (Such fluid flow channels may be connected to a fluid-supply conduit 56, and a fluid-exhaust conduit 57, both as shown in generic representation in FIG. 4.) It will be appreciated that such designs may be particularly suited to instances in which it is desired that all of the dynamic heat-transfer structures (e.g., fins) of all of the elements 60 of array 50, are exposed to a common heat-transfer fluid. (By a common fluid is meant a fluid that is at the same nominal temperature e.g. as controlled to a setpoint by a heating/cooling unit, notwithstanding that some change in the temperature of the fluid may occur as it progresses past successive heat-transfer structures of elements 60). In some embodiments, support block(s) 51 may be made of a low thermal conductivity material, e.g. with a thermal conductivity of less than 80 W/m-° C. In further embodiments, support block(s) 51 may comprise a thermal conductivity of less than about 60, 40 or 30 W/m-° C. In still further embodiments, support block(s) 51 may be a thermally insulating material, e.g. with a thermal conductivity of less than about 25 W/m-° C. Such arrangements may advantageously enhance the below-described lateral thermal isolation of elements 60 from each other.

At least some of the temperature-controllable elements of a temperature-controllable array, e.g., the main bodies thereof, may be laterally thermally isolated from each other. That is, any particular element may be laterally thermally isolated at least from its neighboring element or elements. Such lateral thermal isolation can be viewed in terms of the ability for thermal energy to be conducted within the main body of an element, relative to the ability for thermal energy to be conducted from the main body of that element to that of a neighboring element (i.e. across an intervening distance (space) separating the main body of that element from the main body of the neighboring element). For such lateral thermal isolation to be achieved, the former ability must predominate over the latter ability. Lateral thermal isolation of elements from each other can be provided in any suitable way, and multiple methods of isolation may be used for a single element. In general, such methods may rely on the providing of a material or materials with relatively low thermal conductivity, in the intervening space between the surfaces of main bodies of adjacent elements (in particular, in between the surfaces of main bodies of adjacent elements that most closely face each other). Thus, in the embodiment shown in FIG. 2, an air gap is provided between the heat-exchange modules 63 of adjacent elements 60. Since the thermal conductivity of air is less than 0.1 W/m-° C., this may provide for effective thermal isolation (e.g., as long as the air gap is at least about 0.1 mm or more to minimize the chance of an unacceptably high rate of radiative heat-transfer between the surfaces of the adjacent main bodies). In various embodiments, such an air gap may be at least about 0.2, 0.5, 1.0, or 2.0 mm, at the point of closest approach of the elements (e.g., the main bodies thereof) to each other. It will be appreciated that the term air gap is used generically and that any gaseous fluid of suitably low thermal conductivity (e.g., nitrogen), or even a partial vacuum, may be present in such a gap. In some embodiments at least a portion of the gap between adjacent elements may be filled with a non-gaseous, low-thermal-conductivity fluid (e.g., a thermally insulating oil or grease with a thermal conductivity of less than about 25 W/m-° C.).

In some embodiments, a low-conductivity, solid (i.e., non-fluid) material may be used for such purposes. Such a material is herein termed a thermally insulating spacer, and may be comprised of any non-fluid material, as long as sufficiently low overall thermal conductivity is exhibited. Such a material may be a solid material with a low inherent thermal conductivity, and/or the material may be porous, cellular, etc. so as to comprise void volumes which may contribute to the low overall thermal conductivity of the material. Thus in the exemplary embodiment of FIGS. 2 and 4, a thermally insulating spacer 71 is present between adjacent load-bearing member 62 of elements 60 at the at the points of closest approach of adjacent load-bearing members 62 to each other. In various embodiments, such an insulating spacer may be made of material with a thermal conductivity of less than about 25, 10, or 5 W/m-° C. In some embodiments, such a spacer may made of titanium. In various embodiments, the thickness of a spacer (i.e., in the shortest, lateral dimension of the spacer) may be at least about 0.05, 0.1, or 0.2 mm. In various embodiments, the thickness of a spacer (i.e., in the shortest, lateral dimension of the spacer) may be at most about 5, 2, 1, or 0.5 mm. The thickness of such a spacer may be generally or strictly constant, or it may vary over the length and/or width of the spacer. In particular embodiments, a combination of any of the above approaches may be used. Thus, in FIG. 5, exemplary thermally insulating spacer 71 is provided in the form of a picture-frame border, surrounding an air space. This type of arrangement may be particularly useful in providing that solid portions of spacer material are provided e.g. between adjacent front surfaces 61 of the elements of array 50 (as shown in FIG. 2), so that the maximum support may be provided to cavity skin 3, while also providing that a significant area between neighboring elements comprises an air gap, so as to provide an overall barrier to conduction of thermal energy between the neighboring elements that is as high as possible.

As mentioned above, for lateral thermal isolation to be achieved between two temperature-controllable elements, the ability of thermal energy to be conducted within the main body of each element must predominate over the ability of thermal energy to be conducted from the main body of that element to that of the neighboring element, in order that the temperature of each element can be satisfactorily controlled generally independently of that of the neighboring element. In many instances, the person of ordinary skill may be able to ascertain, by qualitatively assessing any heating and cooling arrangements that are provided in a mold component, whether such lateral thermal isolation is provided. However, in some circumstances it may be useful to at least semi-quantitatively characterize such lateral thermal isolation.

One convenient way in which lateral thermal isolation of an element may be characterized is by the use of the well-known parameter known as thermal resistance (i.e., the inverse of thermal conductance). For any given conductive pathway along a material, the thermal resistance (R) is obtained by equation (1):

R=L/(k*A) (1)

where L is the path length, k is the thermal conductivity of the material (e.g., in W/m-° C.), and A is the cross-sectional area along the pathway (so that R has units of e.g. ° C./W).

It is well known that for conductive pathways in parallel, a collective R for the combined pathways can be obtained by taking the inverse of the individual R's for the separate conductive pathways, adding the inverted R's, and the inverting the sum. Likewise, it is well known that for conductive pathways in series, a collective R for the combined pathways can be obtained by summing the individual R's. Therefore, the thermal resistance to lateral heat flow within the main body of an element 60, which will herein be termed as R_{mb}, can be calculated using equation 1. Since the lateral thermal isolation of such an element is most usefully calculated with the element thermally coupled to the cavity skin (that is, in the configuration in which the molding operation will be performed), any contribution of the cavity skin should be taken into account. Thus, R_{mb} may conveniently include the combined contribution of (parallel) lateral conduction pathways provided by the main body of the element and by the cavity skin to which the main body is thermally coupled to. Thus, for purposes of characterizing the degree of lateral thermal isolation of an element from a nearest neighbor element along all significant conductive pathways therebetween, an R_{mb} (e.g., over a reference length from the lateral center of the main body of the element, to an edge of the main body that is closest to the neighbor element) can be calculated, including the contribution of the cavity skin.

Next, an Rᵢ can be obtained, which is the resistance to conduction that is presented by the intervening space between that element and a second, neighboring element. Such an Rᵢ will be the collective resistance provided by all conductive pathways that cross this intervening space between the first element and the second element. For example, an Rᵢ in a particular situation might be obtained by assessing the thermal resistance represented by any thermally insulating spacers in the intervening space (along with any other components that might be present in a portion of the space, which components are discussed in detail later herein). Again, if series or parallel conductive pathways are present in the intervening space, their contributions can be respectively added or inversely added as described above.

An Rᵢ/R_{mb} ratio (which will be termed the resistance ratio) can thus be obtained which provides an indication of the resistance to conduction over the intervening space between an element and it neighbor, in comparison to the resistance to conduction within the element itself. Such a ratio can likewise then be obtained for any other neighboring elements.

As disclosed herein, a laterally thermally isolated element requires an Rᵢ/R_{mb} ratio for that element, with respect to all nearest-neighbor elements, of at least 1.5. In further embodiments, the Rᵢ/R_{mb} ratio of at least one element 60 with respect to all other neighboring element is at least about 2, 4, 8, 16, 32, or 64.

Another parameter which may also be used to semi-quantitatively assess lateral thermal isolation of an element is the path-length-normalized thermal resistance (Rₚₗ) given by equation (2):

Rₚᵢ=1/(k*A) (2)

where k is the thermal conductivity of the material, and A is the cross-sectional area at a point along the conductive pathway, so that (so that Rₚₗ has units of e.g. ° C./W*m). Such a path-length-normalized thermal resistance is often referred to as thermal resistance per unit length. Alternatively, the Rₚₗ at a given point along a conductive pathway (or a set of parallel pathways) can be considered to be a measure of the area-weighted conductivity at that point of the conductive pathway.

In order to use Rₚₗ to characterize the degree of lateral thermal isolation of an element, a slice can be taken through all lateral conductive pathways (e.g., through all parallel lateral conductive pathways) that are present at a particular location of the main body (e.g., such a slice might pass through the main body of the element and the cavity skin overlying the main body). Typically, but not necessarily, such a slice may have a normal axis that is generally parallel to the conduction pathway(s) at that lateral location of the element. The Rₚₗ provided by each conductive path may then be obtained and the contributions of these parallel resistances may then be obtained by inversion/addition in like manner to that described above, to provide a parameter which will be termed R_{plmb}. It will be appreciated that R_{plmb}'s can be obtained at different lateral locations along an overall conductive pathway (e.g., at locations slicing through the main body near its lateral centerpoint, at locations partway between the centerpoint of the main body and a lateral edge thereof, and at locations proximate the lateral edge).

Similarly, an Rₚₗᵢ can be obtained, which is the path-length-normalized thermal resistance to conduction that is presented by the intervening space which must be crossed to reach a neighboring element, reflecting contributions of all significant conductive pathways that cross the space between the first main body and the second main body. It will be appreciated that an Rₚₗᵢ can be obtained at any point along the relevant pathways (e.g., between the lateral edge of the first main body, and the nearest lateral edge of the second main body).

An Rₚₗᵢ/R_{plmb} ratio can then be obtained (which will be termed the path-length-normalized resistance ratio). It will be appreciated that an R_{plmb} can be obtained at any location (slice) passing through the main body of the element; and, an Rₚₗᵢ can be obtained at any location (slice) passing through the intervening space between the element and a nearest neighbor element. And, such parameters and a ratio thereof can be likewise obtained with respect to the intervening space between the element and any other neighboring elements. In view of these considerations, a laterally thermally isolated element requires an Rₚₗᵢ/R_{plmb}, when obtained at any location within the main body of the element relative to any location of within the intervening space between that element and any neighboring element, of at least 1.5. In further embodiments, the Rₚₗᵢ/R_{plmb}ratio of at least one element 60 is at least about 2, 4, 8, 16, 32, or 64.

Those of ordinary skill will understand that the above treatments are somewhat simplified, relying mainly on geometric parameters of components that provide conductive pathways, and the thermal conductivity of the materials of which the components are made. It will be appreciated that these calculations and the resulting parameters are used for convenience in characterizing the degree of lateral thermal isolation of a given element, and that the presence of various simplifying assumptions does not minimize their usefulness. For example, the face-to-face conduction between intimately contacting surfaces (e.g., between a laterally outward face of a main body of an element, and a face of a thermally insulating spacer that is abutted thereagainst) may be assumed to be perfect (i.e., that any thermal contact resistance therebetween is negligible). Such an assumption may be of no import e.g. in the case of smooth surfaces that are e.g. held firmly together in intimate contact with each other. If, on the other hand, either or both surfaces have rough, structured and/or textured areas, this may be accounted for by using the effective contact area (e.g., the actual microscopic contact area) between the surfaces (estimated if necessary) rather than the nominal (overall) contact area therebetween. Likewise, in such calculations the thermal conductivity provided by air (or any other gaseous fluid present between e.g. a main body and an adjacent main body or a spacer) may generally be neglected.

In addition, in many cases, only the most direct pathway of conduction between a main body of an element, and its nearest neighbor main body (e.g., across the intervening space between the nearest surfaces of the main bodies), need be taken into account, if this pathway dominates other (e.g., more circuitous) pathways. For example, conduction of thermal energy from an element to a neighboring element, through a pathway leading out of a face of the element that is farthest away from the neighboring element, may often be ignored. Further, it will be appreciated that in some embodiments an element (e.g., a main body thereof) may be rearwardly supported, e.g. by a support block, mold base or the like. As disclosed herein, in many embodiments a such a support block may be comprised of a thermally insulating material (and/or, a thermally insulating spacer may be provided between the rearward face of the element and the frontward face of a support block and/or mold base). In such cases, conduction of thermal energy between elements by way of such a circuitous route passing through a rearward insulating material may typically be neglected.

Still further, it will be appreciated that in various embodiments a heating element (e.g., a static heater provided within a cavity of an element) may be used to control the temperature of an element; and/or, a dynamic heat-transfer fluid may be used to control the temperature of an element. In such cases, the presence of such a heating element, and/or the presence of such a fluid, may be neglected. However, in such embodiments, the thermal conductivity of e.g. tubes that may be used to transport such a fluid, which tubes may contact surfaces of neighboring elements and thus provide a conductive pathway therebetween, may need to be taken into account. Likewise, the thermal conductivity of any bolts (as might be used in the assembly of the temperature-controllable array) may need to be taken into account.

Finally, it has been mentioned that in some cases the mold cavity skin may represent the dominant thermal conduction pathway between neighboring elements of a herein-described temperature-controllable array. That is, in some instances the mold cavity skin may provide significantly less resistance to the conduction of thermal energy across the intervening space between neighboring elements than the combined resistance provided by any thermally insulating spacers, air gaps, dynamic heat-transfer tubes, etc., that may be present in the intervening space. In such a case, only the skin may need to be considered, so it may not be necessary to calculate the contributions of such elements. This being the case, in some conventional designs it may be apparent that the lateral thermal conduction pathway provided by a cavity skin (portions of which are thermally coupled to neighboring heating and/or cooling elements) comprises a very low resistance (e.g., because the skin is quite thick and/or highly conductive). In such cases it may be readily apparent that the heating and/or cooling elements are not laterally thermally isolated from each other, based on consideration of the cavity skin alone.

It will be appreciated that there exists an additional consideration beyond the above-described requirements for a minimum Rᵢ/R_{mb} and an Rₚₗᵢ/R_{plmb} ratio. Specifically, the requirement that (at least) two elements of a temperature-controllable array must be laterally thermally isolated from each other, adds a further condition beyond the satisfying of the above ratios. That is, the overall conductive pathway across the intervening space between first and second elements (by which overall pathway is meant the collective pathway provided in combination by parallel conductive pathways through e.g. thermally insulating spacers, air gaps, dynamic heat-transfer tubes, bolts, etc., as may be present in the intervening space) must comprise a resistance maximum along the pathway between the centerpoints of the first and second elements. That is, when following an overall pathway (which may often be comprised of a set of parallel pathways, as described above) from the lateral centerpoint of the first element, to the lateral centerpoint of the second element (which make for convenient points of reference) the resistance to thermal conduction must increase to a maximum value at some point within the intervening space, and must then decrease upon entering the second element. If no such decrease occurs, then by definition a second temperature-controllable element that is laterally thermally isolated from the first temperature-controllable element, is not present. For example, the situation may be a conventional one of a locally heatable or coolable zone that is merely neighbored or partially surrounded by material of a mold component (e.g., by the steel of a mold part) and is thus not laterally thermally isolated as defined herein. In other words, the herein-disclosed temperature-controllable arrays require that the array comprise at least two elements that have a thermal conductance bottleneck (e.g., a thermal choke), interspersed therebetween.

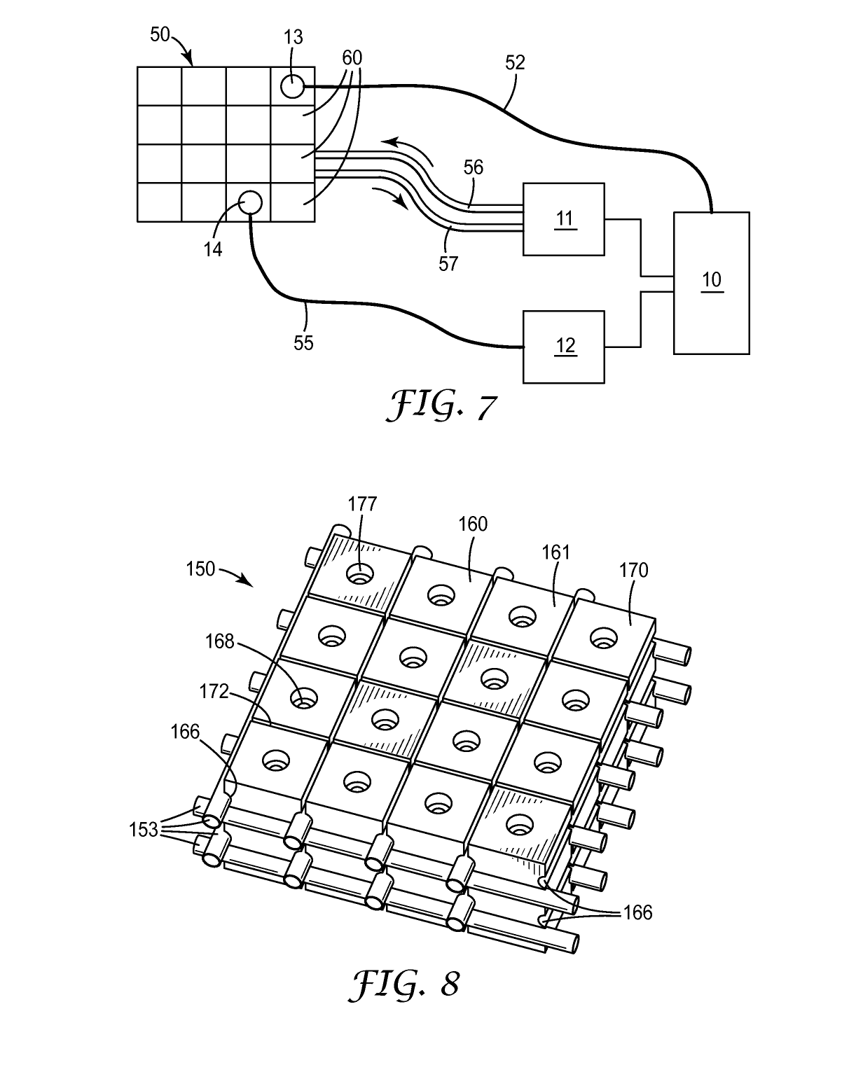

The use of a temperature-controllable array (e.g., array 50 or 150) to control a thermally-controllable array (e.g., array 1) may be discussed with respect to the generic representation shown in FIG. 7. Temperature-controllable array 50 may be operatively connected to controller 10, which resides outside of array 50 and mold component 5 and which may receive information (e.g., via wires 52 as shown in generic representation in FIG. 7) from temperature sensors 13 regarding the temperature of individual elements 60 of array 50. Controller 10 may be operatively connected to (e.g., by wiring as shown in FIG. 7) to a first heat-transfer mechanism control unit 12 (which control unit 12 may be connected, e.g. by wires 55, to e.g. electrical heaters 14 that are thermally coupled to individual elements 60 of array 50) so that controller 10 can direct control unit 12 in the applying of the first heat-transfer mechanism to the various elements 60 of array 50. controller 10 may likewise be operative connected (e.g., by wiring as shown in FIG. 7) to second heat-transfer mechanism control unit 11 (which control unit 11 may be connected, e.g. by fluid-supply conduits 56 and fluid-exhaust conduits 57, to individual elements 60 of array 50 so as to be able to direct a moving heat-transfer fluid into direct or indirect contact with dynamic heat-transfer structures of elements 60), so that controller 10 can direct control unit 11 in the applying of the second heat-transfer mechanism to the various elements 60 of array 50. While for convenience only a single temperature sensor 13 and associated wire, a single electrical element 14 and associated wire, and a single set of supply/exhaust conduits hollow tubing for carrying a moving heat-transfer fluid (with directions of motion indicated by the arrows) are shown in FIG. 7, it will be understood that such components may be provided for any or all individual elements 60 of array 50, as desired. (Thermally insulating spacers, air gaps, etc., as might be present in between the various elements 60 of array 50 are also omitted for clarity). As mentioned, in some embodiments the first heat-transfer mechanism may be a static mechanism (e.g., electrical heating), and the second heat-transfer mechanism may be a dynamic mechanism (e.g., the transfer of thermal energy by a moving heat-transfer fluid). Also as mentioned, not every element 60 needs to be controlled to a different temperature from other elements of the array (for example, two or more elements can be controlled as a block).

It will be evident that the general design depicted in FIGS. 2-6 uses an approach in which each element 60 comprises a heat-exchange module (portion) 63 that is laterally offset from the portion of the main body (load-bearing member 62) that comprises the surface (61) that is in intimate contact with cavity skin 3. And, each element 60 comprises a heat-exchange module 63 that is laterally offset in an opposite direction from that of the heat-exchange modules of adjacent elements 60. It will be evident that such an approach may be particularly useful e.g. for the providing of a temperature-controllable array 50 (and an associated thermally-controllable array of a molding surface), that is a linear (i.e., a 1×N) array (in the exemplary embodiment of FIG. 4, a 1×10 array is depicted).

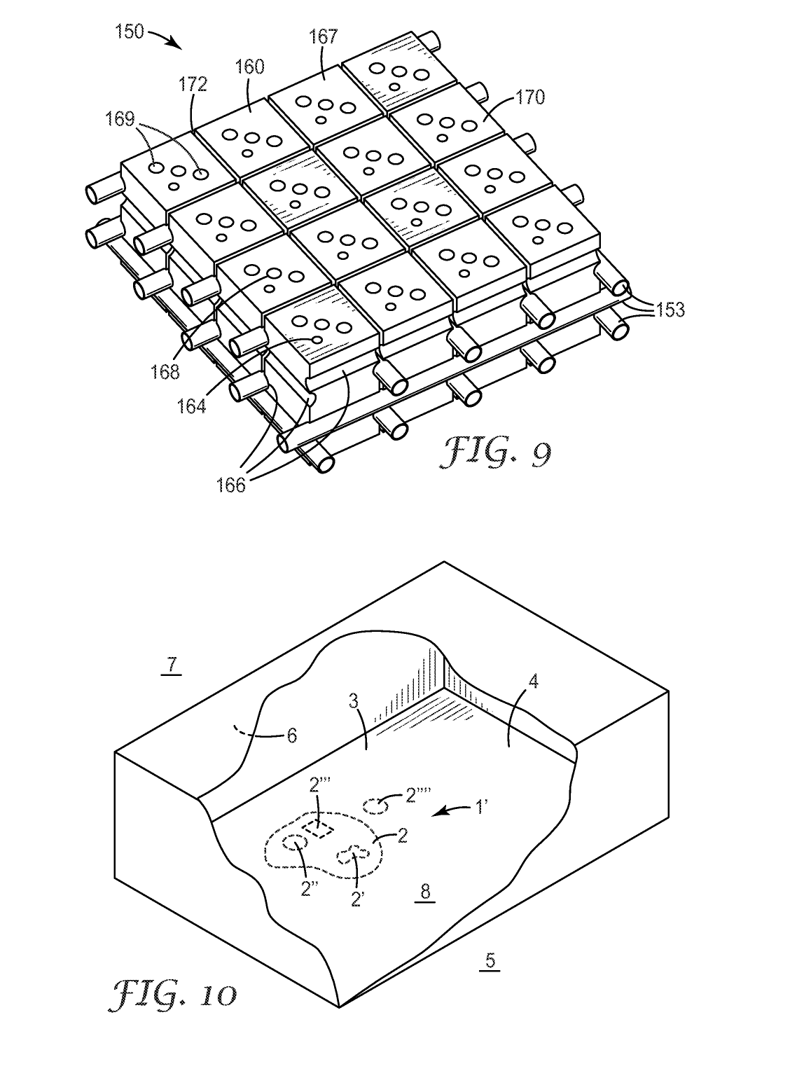

Another general design is shown in exemplary embodiment in FIGS. 8 and 9. The approach exemplified in these Figures may be particularly suited for the providing of a non-linear array; also, it does not rely on the above-described lateral conduction of thermal energy to and/or from a heat-exchange module as such, into another portion of the main body (e.g., a load-bearing member) that comprises a front surface to and/or from which thermal energy is exchanged into a cavity skin. Rather, each element 160 of temperature-controllable array 150 comprises a load-bearing main body 170 with a front surface 161 that may be placed into intimate contact with a back surface of a cavity skin (so as to provide an pixel 2 of a thermally-controllable array 1 in the cavity skin, as described earlier with reference to FIG. 1). In the design of FIGS. 8 and 9, substantially all of the main body 170 of each element 160 may be load-bearing. That is, when array 150 is incorporated into a mold component, a rear surface 167 of some or all elements 160 may be in load-bearing contact with the mold component itself, a mold base, or a support block.

As shown in the rear view of FIG. 9, each main body 170 may comprise at least one open-ended, e.g. rearwardly-open-ended, cavity 169 into which an electrical heating and/or cooling device may be inserted (in the specific embodiment of FIG. 9, two such cavities 169 are provided). In this manner one heat-transfer mechanism may be provided (which will be analogous to the first heat-transfer mechanism that was described above, and may be e.g. a static heat-transfer mechanism). Between individual main bodies 170, a plurality of dynamic heat-transfer tubes (i.e., hollow tubes that allow the passage of a moving heat-transfer fluid therethrough) 153 may extend, with the outside surfaces of heat-transfer tubes 153 being in intimate contact with surfaces 166 of main bodies that are shaped to receive such outer surface of hollow tubes 153. (One such tube 153 has been omitted from FIGS. 8 and 9, so that surfaces 166 may be seen more clearly.) Thus, the aforementioned dynamic heat-transfer structures can encompass such structures as are configured to intimately contact the walls of heat-transfer tubes that contain a moving heat-transfer fluid. Thus, this type of arrangement can provide a second heat-transfer mechanism (which will be analogous to the second, dynamic heat-transfer mechanism that was described above). Any suitable number, spacing, and arrangement of heat-transfer tubes 153 may be used. A common heat-transfer fluid may be passed through all tubes 153; or, in some embodiments, fluids of different temperatures may be passed through different tubes 153.

In each element 160, an open-ended, e.g. rearwardly open-ended, cavity 164 may be provided for a temperature sensor (e.g., an above-described sensor 13). Although the open end of cavity 164 may be conveniently placed in the rear of a main body 170, the closed end of cavity 164 may be positioned (e.g., sufficiently close to front surface 161 of main body 170) to provide satisfactory monitoring of the temperature of main body 170 (e.g., portions of main body 170 closest to cavity skin 3). However, if main body 170 is made of a material of relatively high thermal conductivity, it may be possible to locate the temperature sensor at any convenient location of main body 170.

Elements 160 may be held together e.g. by way of bolts or the like (not shown in FIG. 8 or 9) that may pass through spaces provided between the various elements and which may e.g. extend outward from sides of array 150 so as to be tightenable so as to e.g. tightly hold elements 160 in place (and to ensure that heat-transfer tubes 153 are held in intimate contact with the element surfaces which they abut). If desired, support blocks may be provided on any or all sides of, and/or rearward of, array 150, to which support block bolts (e.g., the above-mentioned bolts) or other fastening mechanism may be used to secure the array in place. Such support blocks may be advantageously made of a thermally insulating material (however, such support blocks do not necessarily have to contain fluid channels therethrough, e.g. of the type exemplified by fluid-flow channels 53 of previously-described support block 51).

Each main body 170 of each element 160 may be laterally thermally isolated from the main body of each adjacent element, in like manner as described above. In the exemplary embodiment of FIGS. 8 and 9, air gaps 172 are shown between surfaces of adjacent elements 160; however, thermally insulating spacers (not visible in FIG. 8 or 9) may also be present. To further enhance lateral thermal isolation, heat-transfer tubes 153 may be made of a material with a relatively low thermal conductivity. In various embodiments, heat-transfer tubes 153 may be made of a material with a thermal conductivity of less than about 100, 80, 60, or 40 W/m-° C. In further embodiments, heat-transfer tubes 153 may be made of a material with a thermal conductivity of at least about 5, 10, 20 or 25 W/m-° C. In particular embodiments, heat-transfer tubes 153 may be made of steel, e.g. stainless steel. In order to facilitate the dynamic heat-transfer from the moving heat-transfer fluid to each main body 170 of each element 160, hollow heat-transfer tubes 153 may comprise relatively thin walls. Thus, in various embodiments heat-transfer tubes 153 comprise a wall thickness of less than about 1.0, 0.5, or 0.2 mm. In summary, use of dynamic heat-transfer tubes 153 with thin walls made of low-thermal-conductivity material, can allow the desired exchange of thermal energy between the moving heat-transfer fluid within the tubes and each element of the array, while minimizing the degree to which the lateral thermal isolation between the elements of the array might be reduced by the tubes passing therebetween.

It is emphasized that any suitable arrangement of main bodies of adjacent elements of a temperature-controllable array, and/or or lateral (direct or indirect) interconnection between main bodies of adjacent elements, may be permitted as long as the herein-described lateral thermal isolation is maintained. It has already been discussed how main bodies of adjacent elements may have thermally insulating spacers of low thermal conductivity material interposed therebetween, may have dynamic heat-transfer tubes made of low-thermal-conductivity material running therebetween, and so on. In further embodiments, main bodies of adjacent elements may have members of a support structure interposed therebetween (e.g., a support lattice may be fitted into a portion of the air gaps between some or all of the adjacent main bodies, which support lattice may enhance the mechanical integrity of the array), as long as such support members are either of sufficiently low thermal conductivity, and/or comprise a sufficiently low cross-sectional area for conduction of thermal energy, so as to preserve the above-described conditions for lateral thermal isolation.

In still further embodiments, it may be possible to allow the presence of one or more integral bridging portions that connect main bodies of certain adjacent elements. Even though such a bridging portion may have high thermal conductivity (being integrally formed with a main body of an element of the array), as long as such a bridging portion, or some section thereof, comprises a sufficiently low cross-sectional area for conduction of thermal energy between adjacent main bodies (e.g., so that such a low-cross-sectional area section of the bridging portion presents a bottleneck to the transfer of thermal energy), it may still be possible to meet the above-described conditions for lateral thermal isolation.

In some embodiments, temperature-controllable array 150 may be positioned in intimate thermal contact with an area of a rear surface of a cavity skin 3 without being necessarily attached to the skin (rather, array 150 and individual elements 160 thereof could be supported, and pressed against the cavity skin, by one or more support blocks of the general type described earlier herein). However, in the particular embodiment shown in FIG. 8, each main body 170 of an element 160 comprises a forwardly-open-ended cavity 177. Each cavity 177 may be configured to receive a hollow boss that is connected to (e.g., is an integral part of) a cavity skin 3. Such a hollow boss may be internally threaded so as to threadably receive the forward end of a bolt that passes e.g. through a bolt-hole 168 of main body 170. Such bolts may be used to attach array 150 to a cavity skin 3 (and may, on the rearward side of array 150, be used to attach array 150 e.g. to a support block, a mold base, or the like).

It should be emphasized that the embodiments depicted in FIGS. 1-9 are merely exemplary embodiments chosen to illustrate the approaches disclosed herein. It will be appreciated that variations are possible. For example, in some embodiments a skin (e.g., a thin, low-thermal-conductivity skin) that comprises a front surface that provides a least a portion of a mold-defining surface of a mold cavity, might be provided as part of mold component. That is, such a skin may be attached to a mold component, and a temperature-controllable array (e.g., 50 or 150) may then be brought into intimate contact with the rear surface of the skin of the mold component and then held in place (whether attached to the skin, or merely held in intimate contact with the skin but not actually attached to it). In other embodiments, a skin (e.g., a thin, low-conductivity skin) may be provided as part of a temperature-controllable array (e.g., array 50 or 150). In some particular embodiments, a separately-made skin may be attached to front surfaces of main bodies of elements of such an array. In other particular embodiments, a skin may be provided directly, by the front surfaces of main bodies of elements of the array. (It will be appreciated such embodiments represent a limiting case in which the thickness “t” of a skin overlying a temperature-controllable element is essentially equal to zero.) Such a case can be considered as one in which the element comprises an integral skin which provides a portion of a molding surface of the mold cavity. In such approaches, an array bearing a skin on the front side thereof (however provided) can be fitted into a provided space of a mold component (in like manner to a mold insert) so that the skin fills an open area in an otherwise already-defined mold cavity surface.

Two exemplary designs of temperature-controllable arrays (50 and 150), and corresponding thermally-controllable arrays 1, have been presented herein. It will be recognized that these are exemplary designs only, and the design of such arrays may vary widely from these exemplary illustrations. For example, in various embodiments the number of pixels 2 of an array 1 may range from e.g. 2, 3, 4, 6, 8, 10, 16, or more. In various embodiments, the size of individual pixels 2 may be at least about 0.2, 0.4, 1.0, 2, or 5 square centimeter. In further embodiments, the size of individual pixels 2 may be at most about 100, 50, 25, 10, 5, 2, or 1.0 square centimeter. In various embodiments, the center-to-center spacing (or, centroid-to-centroid spacing) of pixels 2 from each other may be at least about 0.2, 0.4, 1.0, 2.0, or 5.0 centimeter. In further embodiments, the center-to-center spacing of pixels 2 from each other may be at most about 10, 5, 4, 2, 1, or 0.5 centimeter. In some embodiments, at least one perimeter edge of at least one pixel 2 may be within about 5 mm of a perimeter edge of an adjacent pixel 2. In further embodiments, at least one perimeter edge of at least one pixel 2 may be within about 2, 1, or 0.5 mm of a perimeter edge of an adjacent pixel 2. In various embodiments, any particular pixel 2 can comprise a shape and/or size that is different from that of other pixels 2, and may comprise a regular or irregular shape. In various embodiments, the total area of an array 1 (collectively supplied by the pixels 2, and not including any non-pixel area(s) that may be interspersed between various pixels) may be at least about 2, 5, 10, 20, or 50 square centimeters. In further embodiments, the total area of an array 1 may be at most about 10000, 500, 200, or 100 square centimeters. In various embodiments, the total area provided collectively by the pixels of the array (or arrays) may comprise less than about 50, 30, 20, 10, or 5% of the total surface of mold cavity 8. In various embodiments, the total area provided collectively by the pixels of the array (or arrays) may comprise more than about 50, 70, 80, 90, or 95% of the total surface of mold cavity 8.

In various embodiments, array 1 may be a linear array, or a non-linear array, as described earlier herein. In various embodiments, array 1 may be symmetric (e.g., comprising at least one axis of symmetry, with one exemplary design of a symmetric array shown in FIG. 1), or may be asymmetric. In some embodiments some or all of pixels 2 may be adjacent to other pixels 2 (e.g., with little or no non-pixel area of surface 4 therebetween, excepting such area as may overlie an intervening gap/thermal insulation barrier provided laterally between the temperature-controllable elements that underlie the pixels), e.g. so as to collectively form a contiguous array (e.g., as exemplified in FIG. 1). In other embodiments, at least one pixel may be separated from another pixel or pixels by a non-pixel area of surface 4 (e.g., an area of surface 4 that overlies a non-temperature-controlled portion of a mold component) as discussed later herein with respect to FIG. 10. In various embodiments, a pixel of an array may be laterally separated from its nearest neighbor (in nearest-edge-to-nearest-edge distance) by less than about 10, 5, 2, or 1 mm. In other embodiments one or more pixels may be laterally separated from the other pixel(s) of the array such that the nearest edges of two nearest-neighbor pixels are laterally separated from each other by at least about 0.5, 1, or 5 cm.

Still further variations are possible, e.g. as illustrated in exemplary manner in FIG. 10. For example, pixels 2 of an array 1 do not necessarily have to be provided in any kind of regular spacing or pattern (an exemplary irregular pattern is provided by pixels 2′, 2″, 2″′, and 2″″ of array 1′ of FIG. 10). FIG. 10 also illustrates a case in which pixel 2″″ is separated from the other pixels by a non-pixel area of surface 4. Moreover, in some embodiments, one or more pixels may be partially or completely laterally contained within (e.g., surrounded by) another pixel of the array (an example of this is shown in FIG. 10, in which pixels 2′, 2″, and 2″′ are laterally contained within pixel 2). All that is necessary is that the pixels be provided by a temperature-controllable array, which array comprises individually temperature-controllable elements e.g. at least two of which are laterally thermally isolated from each other, as described herein. For example (with regard to the particular embodiment of FIG. 10), an intervening space (containing e.g. a thermally insulating spacer) may laterally surround each of the temperature-controllable elements that respectively underlie pixels 2′, 2″, and 2″′, so as to laterally isolate these temperature-controllable elements from the temperature-controllable element that underlies pixel 2.

Arrays of any of the designs and arrangements discussed above may be operatively connected to a controller, temperature sensors, first and second heat-transfer mechanism control units, etc., in general manner as discussed earlier with respect to FIG. 7, and subjected to closed-loop control as described earlier herein.

In various embodiments, multiple temperature-controllable arrays (e.g., 50 and/or 150) and corresponding thermally-controllable arrays 1, can be provided in different regions of the skin of a single mold cavity. If desired, in addition to one or more such arrays being provided in a first mold component, one or more such arrays may be provided in a second mold component (noting that conventional injection molding involves a first mold component (often referred to as an A side component), and a second mold component (often referred to as a B side component) that are brought together to form the mold cavity). Multiple mold cavities, each comprising one or more such arrays, may be provided in a single injection-molding apparatus, if desired. In some embodiments the entirety of the cavity skin region comprising the thermally-controllable array may be generally planar, or strictly planar; in other embodiments, at least certain areas of the cavity skin comprising the thermally-controllable array may be non-planar (e.g., curved).

A temperature-controllable array or arrays as disclosed herein, and any components thereof and components provided therewith, may be used with any suitable injection-molding system. As mentioned, such an array or arrays may be attached to, and supported by (whether directly, or indirectly e.g. by way of one or more support blocks as described earlier herein), a mold component (e.g. mold component 5 as shown in generic representation in FIG. 1). Such a mold component may conveniently be a conventional mold component, e.g. made of metal with one or more open-ended cavities therein and often called a mold part, which may be brought together with another mold component to form the mold cavity or cavities. Such a mold component may itself be supported e.g. by a conventional mold base. Such a mold base (not shown in any Figure) may be attached to and supported by a platen (likewise, not shown in any Figure) of an injection-molding system. (The ordinary artisan will be familiar with such mold components, mold bases, and platens).

Such an array or arrays may be provided in combination with (e.g. attached to) a first mold component e.g. of an unmoving side (often referred to as an “A” side or “A” plate) of an injection molding system. Such an injection molding system may comprise a second platen that supports (e.g., by way of a second, conventional mold base) a second mold component 7 that is positioned e.g. on the far side of mold cavity 8 from first mold component 5 (with reference to FIG. 1), which second mold component may provide one or more molding surfaces that combine with molding surface 4 of first mold component 5 (and with any other molding surface that might be provided by mold component 5) to define mold cavity 8 when the first platen and the second platen are brought together. In some embodiments, the second platen may be movable toward the first platen into a first position in which at least one mold cavity is defined by the mated first and second mold components, and away from the first platen into a second position in which a molded part can be removed from the mold cavity (in which case the second mold component is of the type often referred to as a “B” side or plate). As mentioned above, a mold cavity surface of the “B” side mold component may comprise one or more thermally-controllable arrays if desired.

If the injection molding is to involve the injection of a molten resin into the mold cavity, which resin within the cavity is then cooled to solidify the resin into a molded part, any suitable apparatus and associated components may be used to melt polymeric resin and feed the molten resin into the mold cavity(s); e.g., a reciprocating screw apparatus, a screw-over-plunger apparatus, etc. (Again, no such components are shown in the simplified representation of a mold cavity and molding components in FIG. 1). If the injection molding is to involve the injecting of flowable resin at a first, lower temperature into the mold cavity, which resin within the cavity is then heated to promote a chemical reaction that crosslinks the resin into a solid part (i.e., any variation of so-called reaction injection molding), any suitable reaction-injection molding apparatus and associated components may be used to inject such flowable resin and then to promote the chemical reaction and solidification thereof.

In some embodiments, a temperature-controllable array and a corresponding thermally-controllable array may be used with high-injection-pressure molding. In such cases, at least a portion of a main body of one or more individual elements of the array (whether such portion is a load-bearing member of an elements, as in element 60, or such portion is substantially all of a main bodies of an element, as in element 160) may provide a segment of the load path (that is established when the mold components are brought together under pressure) and thus may need to survive such high pressures.

To enable the use of high injection pressures, mold components are often designed to minimize the relative motion of the mold cavity surfaces that are on generally opposing faces of the cavity (i.e., mold cavity surfaces provided by an “A” side mold component, and those provided by a “B” side mold component). One skilled in the art will appreciate that the contacting surfaces of the mold components that form the parting line may be “preloaded” during the process of clamping the mold components together so that the pressure under which flowable resin is subsequently injected does not exceed the preload (which might cause a gap to form between the contacting surfaces and thus possibly result in unacceptable flashing of resin into the gap). To achieve this, a load path should be able to survive a compressive (pre)-load that is greater than the projected area of the mold cavity multiplied by the peak injection pressure. In consequence of this, in at least some embodiments it may be desired to use a temperature-controllable array as described herein in injection molding operations involving a peak resin injection pressure (measured in the mold cavity) of e.g. 20000 psi or more (and thus involving a preload commensurate for use with such injection pressures). Thus, in various embodiments a temperature-controllable array as described herein may be configured to be compatible with an injection pressure (measured in the mold cavity) of at least 15000, 20000, 25000, or 30000 psi. It will be appreciated that certain methods of molding found in the art (e.g., methods involving so-called conformal cooling and the like) do not fall within these embodiments.

In the broadest sense, the approaches discussed above allow the providing of multiple elements of an temperature-controllable array, the temperature of at least some of which elements are capable of being individually monitored in a closed loop manner (keeping in mind, however, that in some instances not every element may necessarily be monitored and/or controlled at all times during a molding operation). Moreover, the transfer of thermal energy into and/or out of each such element can be performed by a first heat-transfer mechanism (e.g. by the use of an electrical heater or cooler) as well as by a second heat-transfer mechanism (e.g., by dynamic heat-transfer as achieved by the use of a moving heat-transfer fluid) that is different from the first mechanism. The combined effect of both heat-transfer mechanisms, as exhibited in the monitored temperature of the element, can be evaluated and one or both heat-transfer mechanisms may be used to maintain the temperature of the element at a given setpoint, to change the temperature to a new setpoint, to return the temperature to a setpoint in response to an outside influence (e.g., filling the mold cavity with high temperature molten resin), and so on.

The application, e.g. the generally simultaneous application, of two different heat-transfer mechanisms to at least one same element of an array, in a closed loop manner, and the application of such a control scheme to multiple elements of an array, is thus disclosed herein. It will be appreciated that the generally simultaneous use of two such mechanisms may present significant advantages in allowing fine control of the temperature of a mold cavity. For example, a first set of elements (e.g., at least one element) of a temperature-controllable array may be subjected to a first heat-transfer mechanism alone (such a first mechanism might, in the absence of any other mechanism, maintain the first elements all at the same temperature, might change the temperature of all of them at a similar rate, etc.). A second set of elements (e.g., at least one element) of the array may be subjected to a first heat-transfer mechanism (which may be the same as the first mechanism applied to the first set of elements; e.g., all of the first and second sets of elements might be cooled by a common heat-transfer fluid). And, the second set of elements may also be subjected to a second heat-transfer mechanism that is different from the first heat-transfer mechanism. This second heat-transfer mechanism may thus offset, or augment, the effect of the first heat-transfer mechanism in the second set of elements (and could do so to different degrees in the different elements of the second set). For example, all elements of an array might be cooled by a common heat-transfer fluid; and, some elements of the array might, at the same time, receive a high amount of electric heating power, some elements might receive a lower amount of electric heating power, and some elements might receive no electric heating power at all. Thus, a balance between two heat-transfer mechanisms (which mechanisms may in some cases partially offset each other, and in some cases might augment each other) can be established for each element of a multi-element array. The effect of the competing mechanisms on the temperature of each element can be monitored, and one or both mechanisms can be altered as desired, e.g. so as to allow different elements of the array to be held at different temperatures.

The concept of generally simultaneous application of two different heat-transfer mechanisms includes cases in which such mechanisms are applied simultaneously to the same temperature-controllable element at least at some time during an injection molding cycle. It also includes cases in which two different heat-transfer mechanisms are applied to the same temperature-controllable element during a molding cycle, even if not necessarily applied at the exact same time (for instance the mechanisms may each be cycled on and off so as to be applied in e.g. rapid succession and/or in a rapidly alternating manner during a step of a molding cycle, e.g. during cooling of a mold cavity).

Arrangements as described herein can be used, for example, to perform differential thermal control of an thermally-controllable array 1 of a mold cavity, by which is meant that at least one pixel of the array may be brought to, and/or maintained at, a temperature that differs from that of at least one other pixel of the array by at least e.g. 5 degrees C. It is noted that such differential thermal control does not require that the pixels be necessarily held at such different temperatures for any minimum period of time (e.g., that they are constantly maintained at such different temperatures), or that the temperatures are actually monitored. And, in some cases, two or more pixels may be held at similar or substantially the same temperatures (for example, several pixels may be controlled in combination as a block). In various embodiments, at least one pixel of an array may be differentially thermally controlled to a temperature that is different from that of another pixel of the array, by at least about 10, 20, or 40 degrees C.

It will be appreciated that the approaches disclosed herein, in which e.g. thermal energy can be transferred into an individual element by one heat-transfer mechanism and can be actively removed from the element by a second, different heat-transfer mechanism, may possess significant advantages over methods in which e.g. thermal energy which is transferred by one mechanism can only leave the element by way of being passively removed (e.g., by gradual conductive dissipation) from the element. It should also be appreciated that it is not necessarily required that two different pixels of an array must be controlled to different, constant temperatures (or, that any particular pixel of an array must be controlled to a specific, constant temperature). Rather, the first and/or second heat-transfer mechanisms might be used e.g. to control the ramping rate at which the temperature of one or more elements of the array is changing. Furthermore, control of the temperatures of the elements of a temperature-controllable array may not necessarily cause the corresponding pixels of the associated thermally-controllable array of the mold cavity surface to be controlled to these same exact temperatures (however, this may occur in some instances). It will also be appreciated that the use of multiple temperature-controllable elements of a temperature-controllable array, does not preclude the presence of other elements that, while they may e.g. be physically similar to the temperature-controllable elements, are not necessarily actively controlled (in some cases, the temperature of such elements may not even be monitored).

It will be appreciated that use of arrays such as described herein may be advantageously used e.g. in the production of molded parts of relatively complicated shapes, particularly such parts as might have relatively thin sections adjacent relatively thick sections. Particularly in such cases, the use of arrays as described herein may provide for more uniform mold filling, for reduced stress in the final molded parts, and so on. In some embodiments, such arrays may be used in the well-known type of injection molding in which molten thermoplastic resin is injected into a cavity and then is cooled to solidify the resin into a molded part. Differential thermal control of the array (or arrays) may be performed e.g. during injection of the resin into the cavity, and/or during the cooling of the resin to solidify it, according to any suitable arrangement. Such arrays may also be used in so-called reactive injection molding in which a flowable resin (comprising any suitable molecules, oligomers, polymers, etc., that are reactive, crosslinkable, and the like) is injected into a cavity and then is heated to promote one or more types of chemical reaction that solidify the flowable resin into a molded part. Differential thermal control of the array (or arrays) may be performed e.g. during injection of the resin into the cavity, and/or during the heating of the resin to solidify it, according to any suitable arrangement.

### LIST OF EXEMPLARY EMBODIMENTS

### Embodiment 1

An injection molding apparatus, comprising: a mold component comprising a skin comprising at least a front surface, wherein the skin comprises at least one region in which the front surface of the skin defines a portion of a molding surface of a mold cavity, wherein the mold component also comprises at least one temperature-controllable array, which array comprises a plurality of individually temperature-controllable elements that are thermally coupled to the skin in areas of the at least one region of the skin so that the areas collectively provide a thermally-controllable array in the front surface of the skin, and wherein at least one of the elements of the temperature-controllable array is laterally thermally isolated from the other element(s) of the temperature-controllable array.

### Embodiment 2

The apparatus of embodiment 1 wherein at least some of the individually temperature-controllable elements are configured to be heated and/or cooled by a first heat-transfer mechanism and are further configured to be heated and/or cooled by a second heat-transfer mechanism that is different from the first heat-transfer mechanism.

### Embodiment 3

The apparatus of embodiment 2 wherein the first heat-transfer mechanism comprises at least one electrical heater that is thermally coupled to a high-thermal-conductivity main body of the element and wherein the second heat-transfer mechanism comprises at least one dynamic heat-transfer structure that is defined by the high-thermal-conductivity main body of the element.

### Embodiment 4

The apparatus of embodiment 3 wherein the at least one electrical heater is an electrical-resistance heater and wherein the at least one dynamic heat-transfer structure is provided by a plurality of dynamic heat-transfer fins that extend integrally from the main body.

### Embodiment 5

The apparatus of embodiment 3 wherein the at least one electrical heater is an electrical-resistance heater and wherein the at least one dynamic heat-transfer structure is provided by a plurality of dynamic heat-transfer contact surfaces that are configured to thermally couple to a plurality of dynamic heat-transfer hollow tubes.

### Embodiment 6

The apparatus of any of embodiments 1-5 wherein the skin in at least the areas that collectively provide the thermally-controllable array, is made of a material with a thermal conductivity of less than about 100 W/m-° C.

### Embodiment 7

The apparatus of any of embodiments 1-5 wherein the skin in at least the areas that collectively provide the thermally-controllable array, is made of a material with a thermal conductivity of between 5 W/m-° C. and 80 W/m-° C. and comprises an aspect ratio l/t of at least 2:1.

### Embodiment 8

The apparatus of any of embodiments 1-5 wherein the skin in at least the areas that collectively provide the thermally-controllable array, is made of a material with a thermal conductivity of between 5 W/m-° C. and 80 W/m-° C. and comprises an aspect ratio l/t of at least 4:1.

### Embodiment 9

The apparatus of any of embodiments 1-8 wherein the mold component, and the at least one temperature-controllable array and the individually temperature-controllable elements thereof, are configured to withstand molding operations involving pressures, as measured in the mold cavity, of 20 ksi or greater.

### Embodiment 10

The apparatus of any of embodiments 1-9 wherein at least some of the temperature-controllable elements each comprise a main body comprising a load-bearing heat-transfer member that is thermally coupled to the skin, and wherein the heat-transfer element further comprises a heat-exchange module that is laterally thermally coupled to the load-bearing heat-transfer member.

### Embodiment 11

The apparatus of any of embodiments 1-10 wherein a high-thermal-conductivity main body of an element of the temperature-controllable array comprises a thermal conductivity of at least about 100 W/m-° C., and wherein at each point of closest approach of the main body of the element to a main body of a neighboring element, the main body of the element is laterally separated from the main body of each neighboring element, by at least one spacing layer comprising one or more materials with a thermal conductivity of less than 25 W/m-° C.

### Embodiment 12

The apparatus of embodiment 11 wherein the at least one spacing layer comprises an air gap in at least a portion of a space between the element and a neighboring element.

### Embodiment 13

The apparatus of any of embodiments 11-12 wherein the at least one spacing layer comprises a spacer body comprising a solid material with a thermal conductivity of less than 25 W/m-° C. in at least a portion of a space between the element and a neighboring element.

### Embodiment 14

The apparatus of any of embodiments 1-13 wherein the temperature-controllable array comprises at least four individually temperature-controllable elements that collectively form a contiguous array.

### Embodiment 15

The apparatus of any of embodiments 1-14 wherein the skin in the areas that collectively provide the thermally-controllable array is provided as part of the mold component and comprises a rear surface against which temperature-controllable array is intimately contacted.

### Embodiment 16

The apparatus of any of embodiments 1-14 wherein the skin in the areas that collectively provide the thermally-controllable array is provided as part of the temperature-controllable array and is attached thereto prior to incorporation of the temperature-controllable array into the mold component.

### Embodiment 17

The apparatus of any of embodiments 1-14 wherein the skin in the areas that collectively provide the thermally-controllable array is provided as part of the temperature-controllable array and is collectively provided by integral skins of the elements of the temperature-controllable array.

### Embodiment 18

The apparatus of any of embodiments 1-17 wherein the at least one temperature-controllable array comprises a first temperature-controllable array that provides a first thermally-controllable array in the front surface of the skin; and, wherein the mold component further comprises at least a second temperature-controllable array, which array comprises a second plurality of individually temperature-controllable elements that are thermally coupled to the skin in areas of a second region in which the front surface of the skin defines a portion of a molding surface of a mold cavity, so that the areas of the second region provide a second thermally-controllable array in the front surface of the skin, and wherein at least some of the elements of the second temperature-controllable array are laterally thermally isolated from the other elements of the second temperature-controllable array.

### Embodiment 19

The apparatus of any of embodiments 1-18 wherein the mold component is a first mold component and wherein the molding surface is a first molding surface; and, wherein the apparatus further comprises a second mold component comprising a second low-thermal-conductivity skin comprising at least a front surface, wherein the second low-thermal-conductivity skin comprises at least one region in which the front surface of the second skin defines a portion of a second molding surface configured so that when the first and second mold components are brought together, the first and second molding surfaces combine to at least partially define the mold cavity.

### Embodiment 20

The apparatus of any of embodiments 1-19 wherein the at least one temperature-controllable array of the first mold component comprises a first temperature-controllable array that provides a first thermally-controllable array in the front surface of the skin of the first mold component; and, wherein the second mold component comprises at least a second temperature-controllable array, which array comprises a second plurality of individually temperature-controllable elements that are thermally coupled to the second skin in areas of a second region in which the front surface of the second skin defines a portion of the second molding surface, so that the areas of the second region provide a second thermally-controllable array in the front surface of the second skin, and wherein at least some of the elements of the second temperature-controllable array are laterally thermally isolated from the other elements of the second temperature-controllable array.

### Embodiment 21

The apparatus of embodiment 20 wherein the first mold component is supported by a first platen and wherein the second mold component is supported by a second platen, and wherein at least one of the first and second platens is a movable platen configured so that the at least one first molding surface of the first mold component and the at least one second molding surface of the second mold component collectively define at least one mold cavity when the first platen and the second platen are brought together.

### Embodiment 22

The apparatus of embodiment 21 wherein the first platen is stationary and the second platen is movable toward the first platen into a first position in which the at least one mold cavity is defined, and away from the first platen into a second position in which a molded part can be removed from the mold cavity.

### Embodiment 23

The apparatus of any of embodiments 1-22 wherein at least one temperature-controllable element exhibits an Rᵢ/R_{mb} ratio, with respect to all nearest-neighbor elements, of at least about 1.5.

### Embodiment 24

The apparatus of any of embodiments 1-23 wherein at least one temperature-controllable element exhibits an Rₚₗᵢ/R_{plmb} ratio, with respect to all nearest-neighbor elements, of at least about 1.5.

### Embodiment 25

The apparatus of any of embodiments 1-24 wherein a conductive pathway across an intervening space between a first temperature-controllable element and a second, laterally neighboring temperature-controllable element exhibits, at some point along the pathway within the intervening space, a thermal resistance that is the maximum thermal resistance found along a pathway extending from a centerpoint of a main body of the first temperature-controllable element to a centerpoint of a main body of the second temperature-controllable element.

### Embodiment 26

A process of injection molding, comprising: providing a mold cavity comprising a molding surface comprising at least one thermally controllable array comprising a plurality of areas, each of which areas is thermally coupled to a temperature-controllable element of a temperature-controllable array; injecting a flowable molding resin into the mold cavity; and, altering the temperature of the injected resin within the cavity to cause the resin to solidify the resin into a molded part, wherein at least at some time during the process, a first heat-transfer mechanism and a second heat-transfer mechanism that is different from the first heat-transfer mechanism, are generally simultaneously applied to at least one of the temperature-controllable elements of the temperature-controllable array.

### Embodiment 27

The process of embodiment 26 wherein at least at some time during the process, a first heat-transfer mechanism and a second heat-transfer mechanism that is different from the first heat-transfer mechanism, are simultaneously applied to at least one of the temperature-controllable elements of the temperature-controllable array.

### Embodiment 28

The process of any of embodiments 26-27 wherein simultaneous application of the first and second heat-transfer mechanisms is used to control the temperature-controllable element to a predetermined temperature.

### Embodiment 29

The process of embodiment 28 wherein the simultaneous application of the first and second heat-transfer mechanisms is performed during at least a portion of the altering of the temperature of the injected resin within the cavity.

### Embodiment 30

The process of any of embodiments 26-29 wherein at least one of the temperature-controllable elements of the temperature-controllable array is laterally thermally isolated from the other elements of the temperature-controllable array.

### Embodiment 31

The method of any of embodiments 26-30 wherein the first heat-transfer mechanism comprises dynamic heating or cooling of the temperature-controllable element of the temperature-controllable array, that is achieved by using at least one moving heat-transfer fluid to dynamically transfer thermal energy to or from a dynamic heat-transfer structure of the temperature-controllable element of the temperature-controllable array, and wherein the second heat-transfer mechanism comprises electrical heating or cooling of the temperature-controllable element of the temperature-controllable array.

### Embodiment 32

The method of any of embodiments 26-31 wherein the injection molding process comprises injection of a molten resin into the mold cavity and wherein the altering the temperature of the injected resin within the cavity to cause the resin to solidify the resin into a molded part comprises cooling the molten resin; and wherein, at some point during the cooling of the molten resin, some areas of the thermally-controllable array are cooled at a first cooling rate by using the first heat-transfer mechanism alone; and, some other areas of the thermally-controllable array are cooled at a second cooling rate that is lower than the first cooling rate, by simultaneously using the first heat-transfer mechanism to remove thermal energy from each of the other areas and using the second, heat-transfer mechanism to add thermal energy into each of the other areas.

### Embodiment 33

The method of embodiment 32 wherein the first heat-transfer mechanism comprises dynamic cooling with a moving heat-transfer fluid and wherein the second heat-transfer mechanism comprises electrical heating.

### Embodiment 34

The method of embodiment 33 wherein the temperature-controllable elements of the temperature-controllable array are all dynamically cooled with a common moving heat-transfer fluid.

### Embodiment 35

The method of any of embodiments 26-34 wherein the method comprises heating at least some of the areas of the thermally controllable array to at least a first, preheat temperature; injecting molten resin into the mold cavity, during which time at least some of the areas of the thermally controllable array are maintained at least at the first, preheat temperature and at least some other of the areas of the thermally controllable array are cooled to a second temperature that is lower than the first, preheat temperature by at least 5 C; and, after injecting of the molten resin, cooling all of the areas of the thermally controllable array to a third temperature that is lower than the first, preheat temperature by at least 20 C.

### Embodiment 36

The method of any of embodiments 26-31 wherein the injection molding process comprises injection of a curable resin into the mold cavity and wherein the altering the temperature of the injected resin within the cavity to cause the resin to solidify the resin into a molded part comprises heating the curable resin to promote curing of the resin; and wherein, at some point during the heating of the molten resin, some of the areas of the thermally-controllable array are heated at a first heating rate by using the second heat-transfer mechanism alone; and, some other areas of the thermally-controllable array are heated at a second heating rate that is lower than the first heating rate, by simultaneously using the second heat-transfer mechanism to add thermal energy into each of the other areas and using the first heat-transfer mechanism to remove thermal energy from each of the other areas.

### Embodiment 37

The method of embodiment 36 wherein the first heat-transfer mechanism comprises dynamic cooling with a moving heat-transfer fluid and wherein the second heat-transfer mechanism comprises electrical heating.

### Embodiment 38

The method of any of embodiments 26-37 performed with the apparatus of any of embodiments 1-25.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. An injection molding apparatus, comprising:
a mold component comprising a skin comprising at least a front surface, wherein the skin comprises at least one region in which the front surface of the skin defines a portion of a molding surface of a mold cavity,
wherein the mold component also comprises at least one temperature-controllable array, which array comprises a plurality of individually temperature-controllable elements that are thermally coupled to the skin in areas of the at least one region of the skin so that the areas collectively provide a thermally-controllable array in the front surface of the skin,
and wherein at least one of the elements of the temperature-controllable array is laterally thermally isolated from the other element(s) of the temperature-controllable array.

2. The apparatus of claim 1 wherein at least some of the individually temperature-controllable elements are configured to be heated and/or cooled by a first heat-transfer mechanism and are further configured to be heated and/or cooled by a second heat-transfer mechanism that is different from the first heat-transfer mechanism.

3. The apparatus of claim 2 wherein the first heat-transfer mechanism comprises at least one electrical heater that is thermally coupled to a high-thermal-conductivity main body of the element and wherein the second heat-transfer mechanism comprises at least one dynamic heat-transfer structure that is defined by the high-thermal-conductivity main body of the element.

4. The apparatus of claim 3 wherein the at least one electrical heater is an electrical-resistance heater and wherein the at least one dynamic heat-transfer structure is provided by a plurality of dynamic heat-transfer fins that extend integrally from the main body.

5. The apparatus of claim 3 wherein the at least one electrical heater is an electrical-resistance heater and wherein the at least one dynamic heat-transfer structure is provided by a plurality of dynamic heat-transfer contact surfaces that are configured to thermally couple to a plurality of dynamic heat-transfer hollow tubes.

6. The apparatus of claim 1 wherein the skin in at least the areas that collectively provide the thermally-controllable array, is made of a material with a thermal conductivity of less than about 100 W/m-° C.

7. The apparatus of claim 1 wherein the mold component, and the at least one temperature-controllable array and the individually temperature-controllable elements thereof, are configured to withstand molding operations involving pressures, as measured in the mold cavity, of 20 ksi or greater.

8. The apparatus of claim 1 wherein a high-thermal-conductivity main body of an element of the temperature-controllable array comprises a thermal conductivity of at least about 100 W/m-° C., and wherein at each point of closest approach of the main body of the element to a main body of a neighboring element, the main body of the element is laterally separated from the main body of each neighboring element, by at least one spacing layer comprising one or more materials with a thermal conductivity of less than 25 W/m-° C.

9. The apparatus of claim 8 wherein the at least one spacing layer comprises an air gap in at least a portion of a space between the element and a neighboring element.

10. The apparatus of claim 8 wherein the at least one spacing layer comprises a spacer body comprising a solid material with a thermal conductivity of less than 25 W/m-° C. in at least a portion of a space between the element and a neighboring element.

11. The apparatus of claim 1 wherein the skin in the areas that collectively provide the thermally-controllable array is provided as part of the mold component and comprises a rear surface against which temperature-controllable array is intimately contacted.

12. The apparatus of claim 1 wherein the skin in the areas that collectively provide the thermally-controllable array is provided as part of the temperature-controllable array and is attached thereto prior to incorporation of the temperature-controllable array into the mold component.

13. The apparatus of claim 1 wherein the skin in the areas that collectively provide the thermally-controllable array is provided as part of the temperature-controllable array and is collectively provided by integral skins of the elements of the temperature-controllable array.

14. A process of injection molding, comprising:
providing a mold cavity comprising a molding surface comprising at least one thermally controllable array comprising a plurality of areas, each of which areas is thermally coupled to a temperature-controllable element of a temperature-controllable array;
injecting a flowable molding resin into the mold cavity;
and, altering the temperature of the injected resin within the cavity to cause the resin to solidify the resin into a molded part,
wherein at least at some time during the process, a first heat-transfer mechanism and a second heat-transfer mechanism that is different from the first heat-transfer mechanism, are generally simultaneously applied to at least one of the temperature-controllable elements of the temperature-controllable array.

15. The process of claim 14 wherein simultaneous application of the first and second heat-transfer mechanisms is performed during at least a portion of the altering of the temperature of the injected resin within the cavity.

16. The process of claim 14 wherein at least one of the temperature-controllable elements of the temperature-controllable array is laterally thermally isolated from the other elements of the temperature-controllable array.

17. The method of claim 14 wherein the first heat-transfer mechanism comprises dynamic heating or cooling of the temperature-controllable element of the temperature-controllable array, that is achieved by using at least one moving heat-transfer fluid to dynamically transfer thermal energy to or from a dynamic heat-transfer structure of the temperature-controllable element of the temperature-controllable array, and wherein the second heat-transfer mechanism comprises electrical heating or cooling of the temperature-controllable element of the temperature-controllable array.

18. The method of claim 17 wherein the first heat-transfer mechanism comprises dynamic cooling of the temperature-controllable element, and wherein the second heat-transfer mechanism comprises electrical heating of the temperature-controllable element.

19. The method of claim 14 wherein the injection molding process comprises injection of a molten resin into the mold cavity and wherein the altering the temperature of the injected resin within the cavity to cause the resin to solidify the resin into a molded part comprises cooling the molten resin; and wherein, at some point during the cooling of the molten resin:
some areas of the thermally-controllable array are cooled at a first cooling rate by using the first heat-transfer mechanism alone; and, some other areas of the thermally-controllable array are cooled at a second cooling rate that is lower than the first cooling rate, by simultaneously using the first heat-transfer mechanism to remove thermal energy from each of the other areas and using the second, heat-transfer mechanism to add thermal energy into each of the other areas.

20. The method of claim 14 wherein the injection molding process comprises injection of a curable resin into the mold cavity and wherein the altering the temperature of the injected resin within the cavity to cause the resin to solidify the resin into a molded part comprises heating the curable resin to promote curing of the resin; and wherein, at some point during the heating of the molten resin:
some of the areas of the thermally-controllable array are heated at a first heating rate by using the second heat-transfer mechanism alone; and, some other areas of the thermally-controllable array are heated at a second heating rate that is lower than the first heating rate, by simultaneously using the second heat-transfer mechanism to add thermal energy into each of the other areas and using the first heat-transfer mechanism to remove thermal energy from each of the other areas.
